(19) United States
(12) Patent Application Publication
(10) Pub. No.: US 2015/0019966 A1
(43) Pub. Date: Jan. 15, 2015

(54) METHOD FOR PROCESSING DATA AND ELECTRONIC DEVICE THEREOF

(71) Applicant: Samsung Electronics Co., Ltd., Gyeonggi-do (KR)

(72) Inventors: Yong-Joon Jeon, Gyeonggi-do (KR); Pil-Joo Yoon, Gyeonggi-do (KR)

(21) Appl. No.: 14/329,634

(22) Filed: Jul. 11, 2014

(30) Foreign Application Priority Data
Jul. 12, 2013 (KR) 10-2013-0082223

(51) Int. Cl. G06F 3/0484; G06F 3/0481

(52) U.S. Cl. CPC G06F 3/04842; G06F 3/04817
USPC 715/716; 715/808

(57) ABSTRACT

A method for outputting accompanying data received together with a message. The method can determine whether accompanying data is included in at least one received message and, when the accompanying data is included, display a notification message that includes notification information about the accompanying data and, when the notification information is chosen, directly output the accompanying data.

### PRIORITY

The present application is related to and claims priority under 35 U.S.C. §119(a) to a Korean Patent Application filed in the Korean Intellectual Property Office on Jul. 12, 2013 and assigned Serial No. 10-2013-0082223, the contents of which are herein incorporated by reference.

### TECHNICAL FIELD

The disclosure relates to a method for processing data and an electronic device thereof.

### BACKGROUND

With the growth of mobile communication technologies, electronic devices are used as individual essential communication devices. Further, as the electronic devices provide not only a voice communication function but also various supplementary services of camera, data communication, video play, audio play, messenger, schedule management, alarm functions and the like, various programs capable of using the functions are used, and even methods for communication between users are increasing.

In the conventional art, when an electronic device chooses an icon of accompanying data so as to confirm the accompanying data included in a received Social Network Service (SNS) message, i.e., so as to confirm the accompanying data included in a notification of the SNS message, the electronic device is not able to confirm the accompanying data until the electronic device enables an SNS program to display a region corresponding to the received SNS message on a display unit of the electronic device.

### SUMMARY

To address the above-discussed deficiencies, it is a primary object to provide a method and apparatus capable of effectively displaying a received message and accompanying data included in the received message, and confirming the accompanying data by simple handling in an electronic device.

Various exemplary embodiments of the disclosure can provide a method and apparatus capable of confirming accompanying data included in a received message through various methods in an electronic device.

The above aspects are achieved by providing a method for processing data and an electronic device thereof.

According to various exemplary embodiments of the disclosure, an operation method of an electronic device may provide the operations of determining whether accompanying data is included in at least one received message and, when the accompanying data is included, displaying a notification message that includes notification information about the accompanying data and, when the notification information is chosen, directly outputting the accompanying data.

According to various exemplary embodiments of the disclosure, the accompanying data may include at least one of image data, audio data, and text data.

According to various exemplary embodiments of the disclosure, the operation of outputting the image data may include the operation of displaying the image data as a wallpaper screen of a display unit.

According to various exemplary embodiments of the disclosure, the operation of outputting the image data may further include the operations of displaying a user interface of a program receiving the message, and displaying the image data as a wallpaper screen of the displayed user interface.

According to various exemplary embodiments of the disclosure, the operation of outputting the audio data may output the audio data through a program of controlling a sound of the electronic device. According to one exemplary embodiment of the disclosure, the operation of outputting the audio data may display a tool of controlling the outputting audio data in a predetermined region of a display unit or a notification bar region thereof.

According to various exemplary embodiments of the disclosure, the operation of outputting the audio data may further include the operations of displaying a user interface of a program receiving the message, and outputting the audio data as background music of the displayed user interface.

According to various exemplary embodiments of the disclosure, the operation of displaying the notification message may include the operations of displaying the notification message in a separate notification window or notification bar, and displaying an icon corresponding to the notification information about the accompanying data in a predetermined region of the displayed notification window or notification bar. According to one exemplary embodiment of the disclosure, the method may further include the operation of, if outputting the contents of the accompanying data, changing the icon corresponding to the notification information into a message confirmation icon and displaying the message confirmation icon.

According to various exemplary embodiments of the disclosure, the operation of displaying the notification message may further include the operations of displaying the notification message in a separate notification window or notification bar and, when the received message includes no accompanying data, displaying a message confirmation icon in a predetermined region of the displayed notification window or notification bar.

According to various exemplary embodiments of the disclosure, the operation of outputting may further include the operation of processing according to setting information defined in a setting step, and the setting information can be determined including one or more of an operation of controlling to display message contents, an operation of controlling to display still picture data, an operation of controlling to output audio data, and an operation of controlling to output moving picture data.

According to various exemplary embodiments of the disclosure, an electronic device may include a memory for storing data and instructions, and one or more processors for executing computer programs. The processor may provide to determine whether accompanying data is included in at least one received message and, when the accompanying data is included, display a notification message that includes notification information about the accompanying data and, when the notification information is chosen, directly output the accompanying data.

According to various exemplary embodiments of the disclosure, the processor may provide to include at least one of image data, audio data, and text data as the accompanying data.

According to various exemplary embodiments of the disclosure, the processor may provide to display the image data as a wallpaper screen of a display unit.

According to various exemplary embodiments of the disclosure, the processor may provide to display a user interface of a program receiving the message, and display the image data as a wallpaper screen of the displayed user interface.

According to various exemplary embodiments of the disclosure, the processor may provide to output the audio data through a program of controlling a sound of the electronic device.

According to various exemplary embodiments of the disclosure, the processor may provide to display a user interface of a program receiving the message, and output the audio data as background music of the displayed user interface.

According to various exemplary embodiments of the disclosure, the processor may provide to display the notification message in a separate notification window or notification bar, and display an icon corresponding to the notification information about the accompanying data in a predetermined region of the displayed notification window or notification bar. According to one exemplary embodiment of the disclosure, the processor may provide to, if outputting the contents of the accompanying data, change the icon corresponding to the notification information into a message confirmation icon and display the message confirmation icon.

According to various exemplary embodiments of the disclosure, the processor may provide to process according to setting information that is determined including one or more of an operation of controlling to display message contents, an operation of controlling to display still picture data, an operation of controlling to output audio data, and an operation of controlling to output moving picture data.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating a construction of an electronic device according to various exemplary embodiments of the disclosure;

FIGS. 2A to 2C illustrate an operation of processing a message notification window and accompanying data in the electronic device according to various exemplary embodiments of FIG. 1;

FIGS. 3A to 3C illustrate an operation of processing a message notification window and accompanying data in the electronic device according to various exemplary embodiments of FIG. 1;

FIGS. 4A to 4D illustrate an operation of displaying a message notification window in the electronic device according to various exemplary embodiments of FIG. 1;

FIG. 5 illustrates an operation of processing a message notification bar and accompanying data in the electronic device according to various exemplary embodiments of FIG. 1;

FIG. 6 illustrates an operation of processing accompanying data in the electronic device according to various exemplary embodiments of FIG. 1;

FIG. 7 illustrates a notification setting operation in the electronic device according to various exemplary embodiments of FIG. 1; and

FIGS. 8A and 8B are flowcharts illustrating operations in the electronic device according to various exemplary embodiments of FIG. 1.

### DETAILED DESCRIPTION

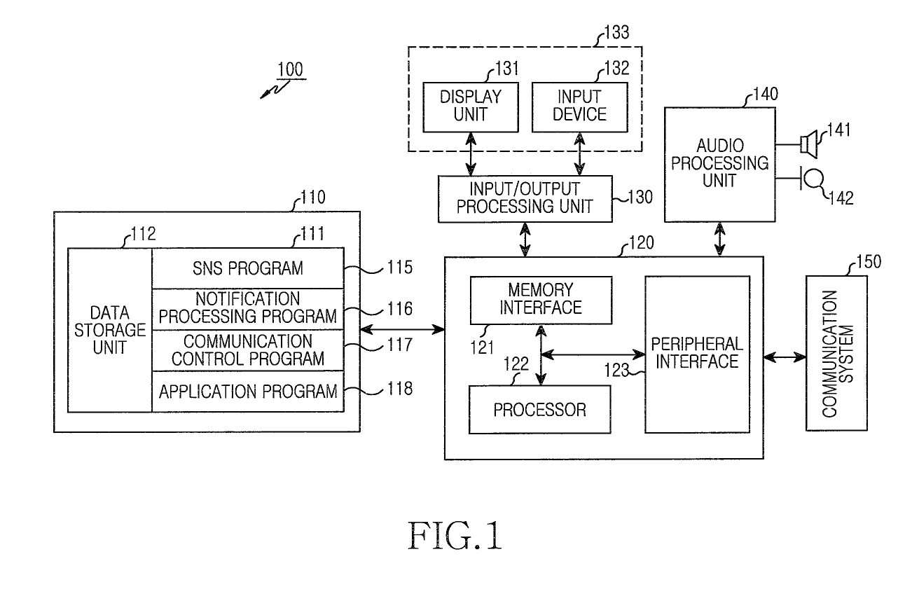

FIGS. 1 through 8B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device. Preferred embodiments of the disclosure will be described herein below with reference to the accompanying drawings. In the following description, well-known functions or constructions are not described in detail since they would obscure the disclosure in unnecessary detail. And, terms described below, which are defined considering functions in the disclosure, can be different depending on user and operator's intention or practice. Therefore, the terms should be defined on the basis of the disclosure throughout this specification.

In describing various exemplary embodiments of the disclosure, an electronic device can be described on a basis of a touchscreen capable of performing within one physical screen an input operation of an input device and a display operation of a display unit. Accordingly, a device construction of the disclosure illustrates the display unit and the input device separately, but the display unit can be expressed to include the input device or indicate the input device.

The disclosure is not limited only to an electronic device including a touchscreen and is applicable to various electronic devices that physically distinguish the display unit and the input device or include only one of the display unit and the input device. In various exemplary embodiments below, an electronic device with a touchscreen can be an electronic device with a touchscreen that includes a separate input device and display unit, a display unit having no input device, or a display unit having an input device.

The electronic device according to the disclosure can be a combination of one or more of various devices such as a mobile communication terminal, a Personal Digital Assistant (PDA), a Personal Computer (PC), a laptop computer, a smartphone, a smart Television (TV), a netbook computer, a Mobile Internet Device (MID), an Ultra Mobile PC (UMPC), a tablet PC, a mobile pad, a media player, a handheld computer, an MPEG audio layer 3 Player (MP3P), a video phone, an electronic book reader, a Portable Media Player (PMP), a mobile medical instrument, an accessory, an electronic accessory, a camera, a wearable device, an electronic watch, a wrist watch, a refrigerator, an air conditioner, a cleaner, a fuzzy robot, an audio, an oven, a microwave range, a washer, an electronic bracelet, an electronic necklace, an air cleaner, an electronic frame, a set-top box, a TV box (Samsung HomeSync™, Apple TV™, or Google TV™), an electronic dictionary, a car infotainment device, a vessel electronic equipment (e.g., a vessel navigator, a gyrocompass and the like), a flight electronic instrument, a security instrument, an electronic clothing, an electronic key, a camcorder, a game console, various medical instruments (Magnetic Resonance Angiography (MRA), Magnetic Resonance Imaging (MRI), Computerized Tomography (CT), a camera, an ultrasound device and the like), a TV, a Digital Video Disk (DVD) player, a navigation device, a Global Positioning System (GPS), an Event Data Recorder (EDR), a Flight Data Recorder (FDR), a Head-Mounted Display (HMD), a flat display device, an electronic album, part of a furniture including an electronic device or a building/structure, an electronic board, an electronic signature input device, a projector or the like. It is obvious to those skilled in the art that the electronic device according to the disclosure is not limited to the aforementioned instruments.

In describing in detail the disclosure below, when it is mentioned that one constituent element is ‘connected’ or ‘accessed’ to another constituent element, it should be understood that one constituent element can be directly connected or accessed to another constituent element or the third constituent element can exist in between the two constituent elements and, when it is mentioned that one constituent element is ‘directly connected’ or ‘directly accessed’ to another constituent element, it should be understood that the third constituent element does not exist in between the two constituent elements.

FIG. 1 illustrates a block diagram of an electronic device according to various exemplary embodiments of the disclosure.

As illustrated in FIG. 1, the electronic device 100 includes a memory 110 and a processor unit 120, and can include peripheral devices such as an input/output processing unit 130, an input/output device 133 including a display unit 131 and an input device 132, an audio processing unit 140, and a communication system 150, and other peripheral devices.

Each constituent element is described as follows.

The memory 110 includes a program storage unit 111 storing a program for controlling the operation of the electronic device 100, and a data storage unit 112 storing data generated during program execution. The memory 110 can store data created in the program by an operation of a processor 122.

When the electronic device 100 processes the data of the program, the data storage unit 112 can store a function of the program, an object of the program, a keyword, an identification (ID) code, and information of the peripheral devices of the electronic device 100 which the program can make use of.

The program storage unit 111 can include a Social Networking Service (SNS) program 115, a notification processing program 116, a communication control program 117, and at least one application program. The programs included in the program storage unit 111 are composed of a set of instructions and thus may be expressed as an instruction set.

The SNS program 115 can transmit/receive a message with other electronic devices. The electronic device 100 can transmit/receive a message such as a text and/or a hyperlink through the SNS program 115, and can transmit/receive accompanying data included in the message. The accompanying data can include one or more of picture data (e.g., moving picture and/or still picture), audio data, and text data.

If the electronic device 100 receives a message including accompanying data, the SNS program 115 can display a notification of the received message. If the electronic device 100 chooses the notification of the received message, the SNS program 115 can display a corresponding page of the SNS program 115, and can display the contents of the accompanying data.

The notification processing program 116 can display a notification message in the electronic device 100 instead of the notification of the received message of the SNS program 115. If the electronic device 100 receives a message including accompanying data, the notification processing program 116 can display the received message and a notification of the accompanying data. If the electronic device 100 chooses the displayed notification of the accompanying data or a predetermined region of the displayed notification, the notification processing program 116 can directly output the accompanying data without displaying the SNS program 115.

The communication control program 117 can include at least one software constituent element for controlling communication with at least one counterpart electronic device using the communication system 150.

For example, the communication control program 117 can search a counterpart electronic device for connecting communication. If the counterpart electronic device for communication connection is searched, the communication control program 117 can establish a connection for communication with the counterpart electronic device. The communication control program 117 can control to perform a performance search and session establishment procedure with the connected counterpart electronic device and transmit/receive data with the counterpart electronic device through the communication system 150.

The application program 118 can include a software constituent element for at least one application program installed in the memory 110 of the electronic device 100.

The memory 110 included in the electronic device 100 can be constructed one or more. According to one exemplary embodiment, the memory 110 can perform a function of only the program storage unit 111, can perform a function of only the data storage unit 112, or can perform functions of both the program storage unit 111 and the data storage unit 112 according to use. Physical regions within the memory 110 may not be clearly distinguished because of a characteristic of the electronic device 100.

The processor unit 120 includes a memory interface 121, at least one processor 122, and a peripheral interface 123. Here, the memory interface 121, the at least one processor 122, and the peripheral interface 123, which are included in the processor unit 120, may be integrated as at least one circuit or be implemented as separate constituent elements.

The memory interface 121 can control the access of constituent elements such as the processor 122 or the peripheral interface 123, to the memory 110.

The peripheral interface 123 can control the connection of the memory interface 121 and the processor 122 with an input/output peripheral device of the electronic device 100.

The processor 122 can control the electronic device 100 to provide various multimedia services using at least one software program, and can display a User Interface (UI) operation of the electronic device 100 on the display unit 131 through the input/output processing unit 130 to confirm the UI operation, and can control the input device 132 to provide a service of receiving an instruction from the external of the electronic device 100. The processor 122 can control to execute at least one program stored in the memory 110 and provide a service corresponding to the executed program.

The input/output processing unit 130 can provide an interface between the peripheral interface 123 and the input/output device 133 including the display unit 131 and the input device 132.

The display unit 131 can receive status information of the electronic device 100, an external input character, and a moving picture or still picture from the processor unit 120, construct a UI operation, and display them through the display unit 131.

The input device 132 can provide input data generated by user's choice to the processor unit 120 through the input/output processing unit 130.

For example, the input device 132 may be composed of only a control button or be composed of a keypad so as to receive data for control from the external of the electronic device 100.

Further, the input device 132 can be included together with the display unit 131 in the input/output device 133 such that input/output can be performed in one screen. In this case, the input device 132 used in the input/output device 133 can use one or more of a capacitive method, a resistive (pressure sensing) method, an infrared method, an electromagnetic induction method, and an ultrasonic method.

Further, an input method of the input device 132 can be a method of processing to input an instruction if an input means for inputting is located within a predetermined distance from the touchscreen 133, besides a method of inputting by directly touching the touch screen 133. Terms of a hovering touch, a floating touch, an indirect touch, a proximity touch, and a non-contact input can be used.

The input/output device 133, a device physically combining the input device 132 to the display unit 131 in one screen, can be a touchscreen capable of inputting an instruction by touching a screen construction displayed on the display unit 131 in an operation of the electronic device 100.

Accordingly, the touchscreen can perform all roles of the display unit 131 displaying the UI operation of the electronic device 100 and the input device 132 inputting an external instruction to the electronic device 100. Therefore, the touchscreen can be constructed as the touchscreen 133 by including the display unit 131 and the input device 132 in the following description.

The audio processing unit 140 can provide an audio interface between a user and the electronic device 100 through the speaker 141 and the microphone 142.

The communication system 150 performs a communication function. The communication system 150 can perform communication with a counterpart electronic device using at least any one of mobile communication using a base station, Infrared Data Association (IrDA), Bluetooth, Bluetooth Low Energy (BLE), Wireless Fidelity (WiFi), Near Field Communication (NFC), short-range wireless communication such as Zigbee, Wireless Local Area Network (WLAN) communication, and wired communication.

In describing an exemplary embodiment of the disclosure, displaying in the electronic device 100 or outputting to the electronic device 100 can be terms representing a method of displaying a moving picture, a still picture or a Graphical User Interface (GUI) operation on the touchscreen 133 of the electronic device 100 or outputting a signal sound or a voice audio to the speaker 141. In the following description also, the terms of displaying and outputting can be used as the same meaning, and can be separately described when there is a need to distinguish them.

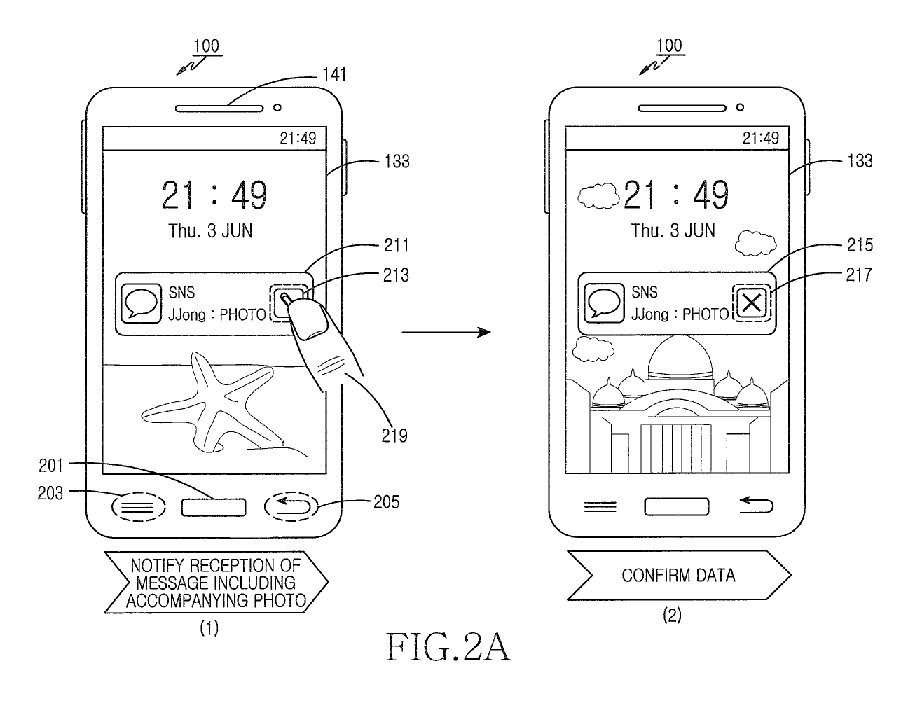

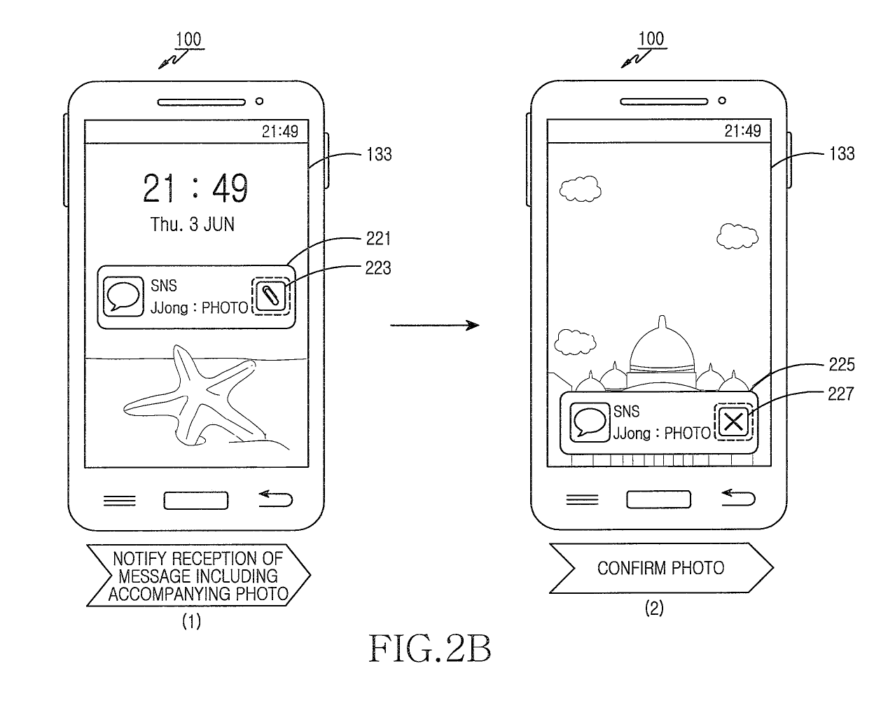

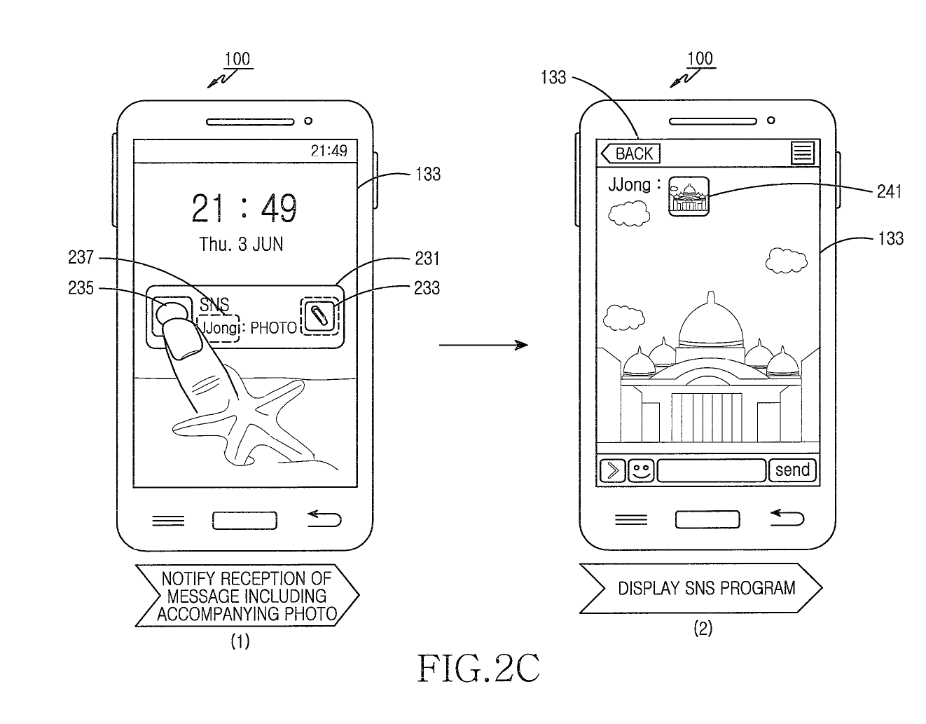

FIGS. 2A to 2C illustrate an operation of processing a message notification window and accompanying data in the electronic device according to various exemplary embodiments of FIG. 1.

In FIG. 2A, if a new message includes accompanying data, the electronic device 100 can confirm the accompanying data through a notification window of the new message.

Referring to FIG. 2A, the electronic device 100 can include the touchscreen 133 in front. The touchscreen 133 can include the input device 132 capable of inputting an instruction by dragging the touchscreen 133 with an input means or moving the input means to a position being at a distance from the touchscreen 133.

Further, the electronic device 100 can include the speaker 141 located at an upper side and capable of outputting a sound. The electronic device 100 can include a button 201 located at a lower side and being one of input devices capable of inputting an instruction by a click. The electronic device 100 can include a touch button 203 or 205 located at a lower side and capable of inputting an instruction through a touch at a fixed location.

Although not illustrated, the speaker 141, the button 201, and the touch button 203 or 205 can be located in the same location or different locations.

Referring to operation (1), the electronic device 100 can receive an SNS message including an image as accompanying data. The electronic device 100 can display a notification of the received message in a predetermined region of the touchscreen 133.

According to one exemplary embodiment, if receiving a message in a wait state, the electronic device 100 can display a received message notification window 211 in a predetermined region of a wait mode screen as in the operation (1). If the received message includes accompanying data, the electronic device 100 can display an accompanying data icon 213 in the received message notification window 211. By choosing (219) the accompanying data icon 213 displayed in the received message notification window 211, the electronic device 100 can confirm the contents of the accompanying data. According to one exemplary embodiment, the wait mode screen can be a lock screen of Android.

Referring to operation (2), if the electronic device 100 chooses the accompanying data displayed in the operation (1), the electronic device 100 can display the accompanying data on a background screen of the touchscreen 133.

According to one exemplary embodiment, if the received accompanying data is image data, the electronic device 100 can display the received message notification window 211 and the accompanying data icon 213 on the wait mode screen of the operation (1), and can confirm the accompanying data by choosing the accompanying data icon 213. The electronic device 100 can display an operation of outputting the accompanying data on a wallpaper screen (i.e., a background screen) of the wait mode screen displayed on the touchscreen 133, with not displaying the SNS program 115 having received the accompanying data on the touchscreen 133. If other image data have been already displayed on the wallpaper screen of the wait mode screen, the electronic device 100 can change the other image data displayed on the wallpaper screen into the chosen accompanying data instead, and display the chosen accompanying data on the wallpaper screen of the wait mode screen.

In displaying the image data on the touchscreen 133 and displaying a new message reception notification, the electronic device 100 can control to display a confirmation icon 217 together with a received message notification window 215 in the operation (2), instead of displaying the accompanying data icon 213 in the operation (1).

If choosing the confirmation icon 217 displayed in the received message notification window 215, the electronic device 100 can restore the wallpaper screen changed into and displaying the accompanying data, to the existing wallpaper screen, and can cancel the displaying of the received message notification window 215.

In a method of canceling the displaying of the received message notification window 215, the electronic device 100 is not limited to a method of choosing the confirmation icon 217, and can control by setting to cancel the displaying of the received message notification window 215 if a predetermined time lapses or a defined instruction is input.

If choosing the confirmation icon 217 displayed in the received message notification window 215, the electronic device 100 can determine a received message confirmation state stored in a database of the memory 110, as ‘reception confirmation’ or ‘read’.

In FIG. 2B, if a new message includes accompanying data, the electronic device 100 can confirm the accompanying data through a notification window of the new message.

Referring to operation (1), the electronic device 100 can receive an SNS message including an image as accompanying data. The electronic device 100 can display a notification of the received message in a predetermined region of the touchscreen 133.

According to one exemplary embodiment, if receiving a message in a wait state, the electronic device 100 can display a received message notification window 221 in a predetermined region of a wait mode screen as in the operation (1). If the received message includes accompanying data, the electronic device 100 can display an accompanying data icon 223 in the received message notification window 221. By choosing the accompanying data icon 223 displayed in the received message notification window 221, the electronic device 100 can confirm the contents of the accompanying data.

Referring to operation (2), if the electronic device 100 chooses the accompanying data displayed in the operation (1), the electronic device 100 can display the accompanying data on a background screen of the touchscreen 133.

According to one exemplary embodiment, the electronic device 100 can display the received message notification window 221 and the accompanying data icon 223 on the wait mode screen of the operation (1), and can confirm the accompanying data by choosing the accompanying data icon 223. The electronic device 100 can display the accompanying data on the wallpaper screen (i.e., the background screen) of the wait mode screen. If other image data have been already displayed on the wallpaper screen of the wait mode screen, the electronic device 100 can change the other image data displayed on the wallpaper screen into the chosen accompanying data instead, and display the chosen accompanying data on the wallpaper screen of the wait mode screen. In displaying the accompanying data on the touchscreen 133 of the electronic device 100, the electronic device 100 can cancel the displaying of some or all of existing displayed UI constructions.

According to one exemplary embodiment, referring to the operation (2), if choosing the accompanying data icon 223 included in the received message notification window 221 of the operation (1), the electronic device 100 can display a chosen accompanying image on the wallpaper screen of the wait mode screen. The electronic device 100 can cancel the displaying of the remnant constructions for controlling the accompanying image displayed as set, excepting a received message notification window 225 and a confirmation icon 227.

If choosing the confirmation icon 227 included in the received message notification window 225, the electronic device 100 can change the accompanying image displayed on the background of the wait mode screen of the electronic device 100 into the existing image and then, cancel the displaying of the received message notification window 225.

If choosing the confirmation icon 227, the electronic device 100 can determine a data reception confirmation state corresponding to the received message and accompanying data of a database, as a ‘reception confirmation’ and ‘read’ state, through the notification processing program 116.

In FIG. 2C, the electronic device 100 can control to display a region capable of answering to a received message through a received message notification window.

Referring to operation (1), the electronic device 100 can receive an SNS message including an image as accompanying data. The electronic device 100 can display a notification of the received message in a predetermined region of the touchscreen 133.

According to one exemplary embodiment, if receiving a message in a wait state, the electronic device 100 can display a received message notification window 231 in a predetermined region of a wait mode screen as in the operation (1). If the received message includes accompanying data, the electronic device 100 can display an accompanying data icon 223 in the received message notification window 231. By choosing an SNS program connection icon 235 displayed in the received message notification window 231, the electronic device 100 can confirm the contents of the received message and can display a predetermined region of the SNS program 115 capable of composing an answer to the received message. In displaying the SNS program 115, the electronic device 100 is not limited to choosing the SNS program connection icon 235 displayed in the received message notification window 231, and can set to display the SNS program 115 if choosing a defined predetermined region of the received message notification window 231 such as ‘Bong’ 237 of received message contents.

Referring to operation (2), the electronic device 100 can display the SNS program 115 on the touchscreen 133 according to an instruction corresponding to the SNS program connection icon 235 or the defined predetermined region 237 of the received message notification window 231 chosen in the operation (1). When the electronic device 100 can determine a wallpaper screen of the SNS program 115, the electronic device 100 can control to display the accompanying data (i.e., image) included in the chosen notification window 231.

If the accompanying data included in the chosen notification window 231 is media data such as an audio or a moving picture, the electronic device 100 can display the SNS program 115 on the touchscreen 133, and can play or display the media data included in the chosen notification window 231.

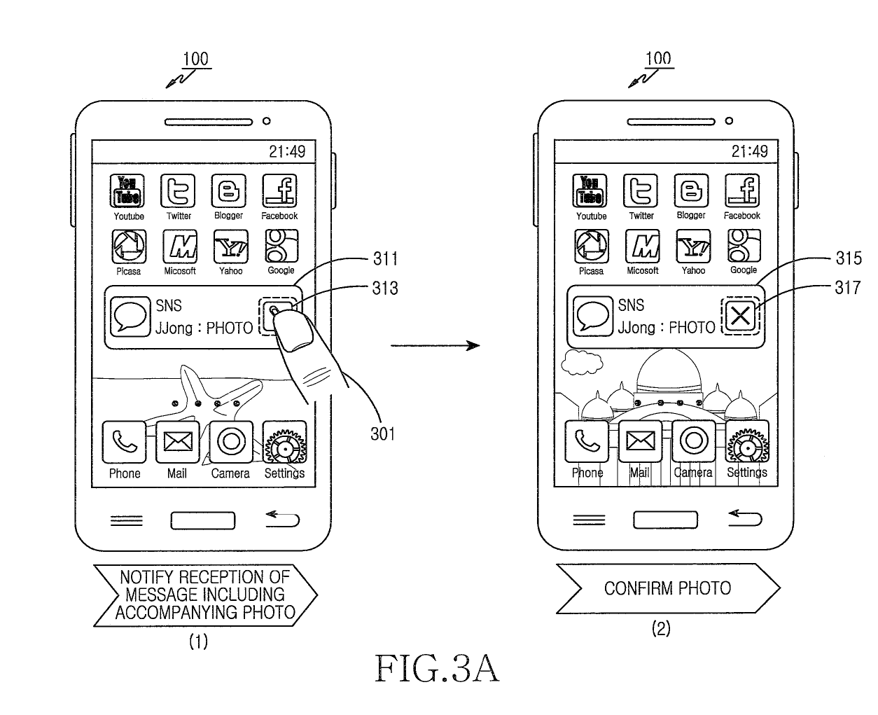

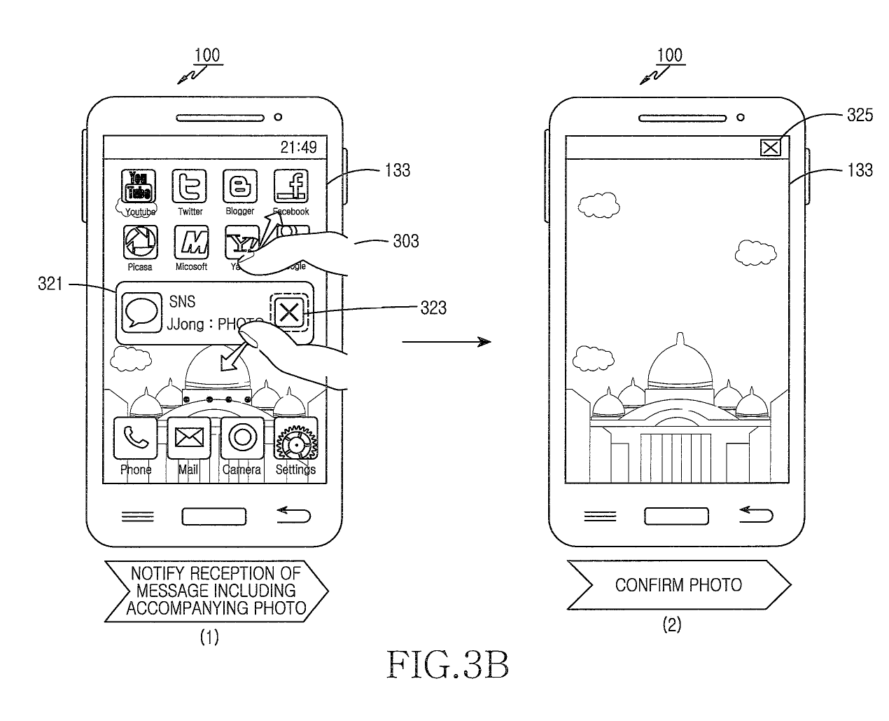

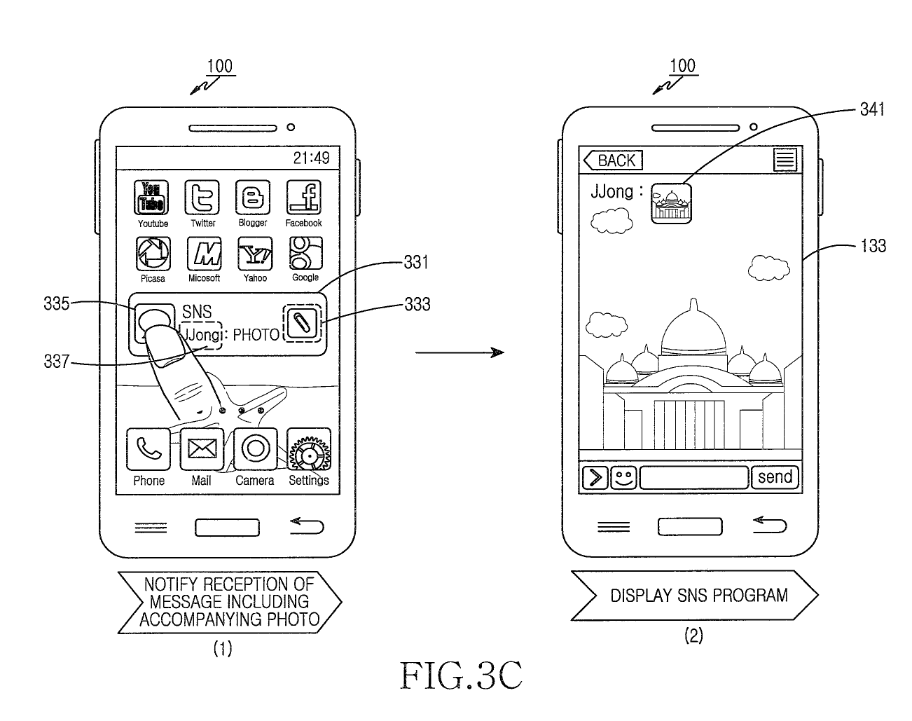

FIGS. 3A to 3C illustrate an operation of processing a message notification window and accompanying data in the electronic device according to various exemplary embodiments of FIG. 1.

In FIG. 3A, if a new message includes accompanying data, the electronic device 100 can confirm the accompanying data through a notification window of the new message.

Referring to operation (1), the electronic device 100 can receive an SNS message including an image as accompanying data. The electronic device 100 can display a notification of the received message in a predetermined region of the touchscreen 133.

According to one exemplary embodiment, if receiving a message in a wait state, the electronic device 100 can display a received message notification window 311 during the use of the electronic device 100 as in the operation (1). If the received message includes accompanying data, the electronic device 100 can display an accompanying data icon 313 in the received message notification window 311. By choosing (301) the accompanying data icon 313 displayed in the received message notification window 311, the electronic device 100 can confirm the contents of the accompanying data.

Referring to operation (2), if the electronic device 100 chooses (301) the accompanying data displayed in the operation (1), the electronic device 100 can display the accompanying data on a background screen of the touchscreen 133.

According to one exemplary embodiment, the electronic device 100 can display the received message notification window 311 and the accompanying data icon 313 on an in-use screen of the electronic device 100 of the operation (1), and can confirm the accompanying data by choosing the accompanying data icon 313. The electronic device 100 can display the accompanying data on the wallpaper screen (i.e., the background screen) of the in-use screen. If other image data have been already displayed on the wallpaper screen of the in-use screen, the electronic device 100 can change the other image data displayed on the wallpaper screen into the chosen accompanying data instead, and display the chosen accompanying data on the wallpaper screen of the in-use screen.

In displaying the image data on the touchscreen 133 and displaying a new message reception notification, the electronic device 100 can control to display a confirmation icon 317(217→317) together with a received message notification window 315 in the operation (2), instead of displaying the accompanying data icon 313 in the operation (1).

In FIG. 3B, if a new message includes accompanying data, the electronic device 100 can confirm the accompanying data through a notification window of the new message.

Referring to operation (1), the electronic device 100 can display a chosen accompanying image on a background screen of the touchscreen 133 as in the operation (2) of FIG. 3A, and can cancel the displaying of some or all of existing displayed UI constructions through a predefined gesture.

According to one exemplary embodiment, the electronic device 100 can display a received message notification window 321 and an accompanying data icon 323 on an in-use screen of the electronic device 100 of the operation (1), and can confirm the accompanying data by choosing the accompanying data icon 323. The electronic device 100 can display the accompanying data on the wallpaper screen (i.e., the background screen) of the in-use screen. If other image data have been already displayed on the wallpaper screen of the in-use screen, the electronic device 100 can change the other image data displayed on the wallpaper screen into the chosen accompanying data instead, and display the chosen accompanying data on the wallpaper screen of the in-use screen. The electronic device 100 can perform a predefined gesture on the in-use screen displaying the chosen accompanying data.

According to one exemplary embodiment, the electronic device 100 can perform a drag operation 303 of, after touching two points on the touchscreen 133, widening a gap between the two points with holding the touch.

Referring to operation (2), in response to the drag operation 303, the electronic device 100 can cancel the displaying of UI constructions of the in-use screen displaying the accompanying data.

According to one exemplary embodiment, in response to the drag operation 303, the electronic device 100 can cancel the displaying of various icons, notification bars, and the received message notification window 321 displayed on the touchscreen 133, and can display only the accompanying data of the background screen. By choosing an X icon 325, the electronic device 100 can control to again display the canceled various icons and notification bars. According to information stored in settings, the electronic device 100 can again display the received message notification window 321 and the confirmation icon 323, or determine a received message confirmation state of a database as a ‘reception confirmation’ or ‘read’ state through the notification processing program 116.

In FIG. 3C, the electronic device 100 can control to display a region capable of answering to a received message through a received message notification window.

Referring to operation (1), the electronic device 100 can receive an SNS message including an image as accompanying data. The electronic device 100 can display a notification of the received message in a predetermined region of the touchscreen 133.

According to one exemplary embodiment, if receiving a message in a wait state, the electronic device 100 can display a received message notification window 331 in a predetermined region of an in-use screen of the electronic device 100 as in the operation (1). If the received message includes accompanying data, the electronic device 100 can display an accompanying data icon 333 in the received message notification window 331. By choosing an SNS program connection icon 335 displayed in the received message notification window 331, the electronic device 100 can confirm the contents of the received message and can display a predetermined region of the SNS program 115 capable of composing an answer to the received message. In displaying the SNS program 115, the electronic device 100 is not limited to choosing the SNS program connection icon 335 displayed in the received message notification window 331, and can set to display the SNS program 115 if choosing a defined predetermined region of the received message notification window 331 such as ‘Hong’ 337 of received message contents.

Referring to operation (2), the electronic device 100 can display the SNS program 115 on the touchscreen 133 according to an instruction corresponding to the SNS program connection icon 335 or the defined predetermined region 337 of the received message notification window 331 chosen in the operation (1). When the electronic device 100 can determine a wallpaper screen of the SNS program 115, the electronic device 100 can control to display the accompanying data (i.e., image) included in the chosen notification window 331.

If the accompanying data included in the chosen notification window 331 is media data such as an audio or a moving picture, the electronic device 100 can display the SNS program 115 on the touchscreen 133, and can play or display the media data included in the chosen notification window 331.

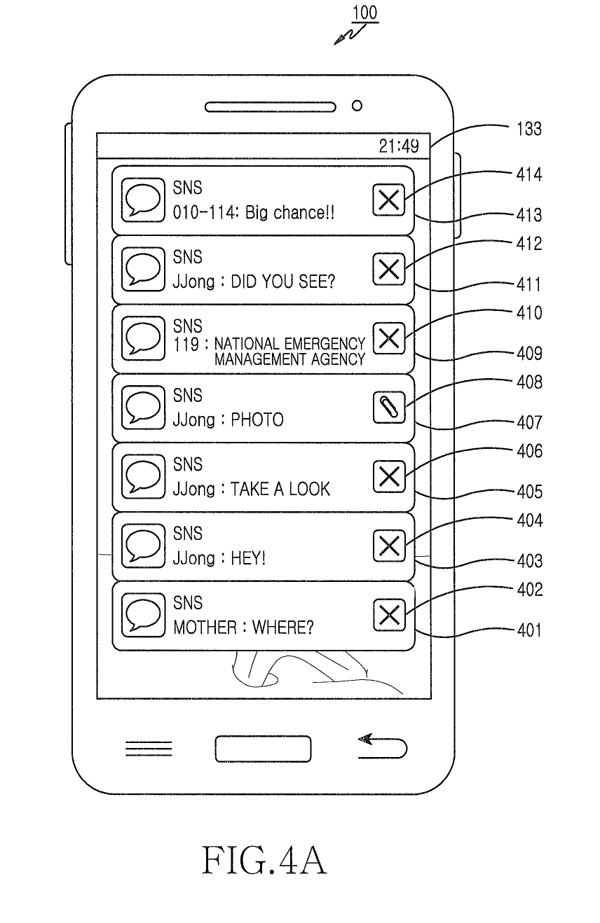

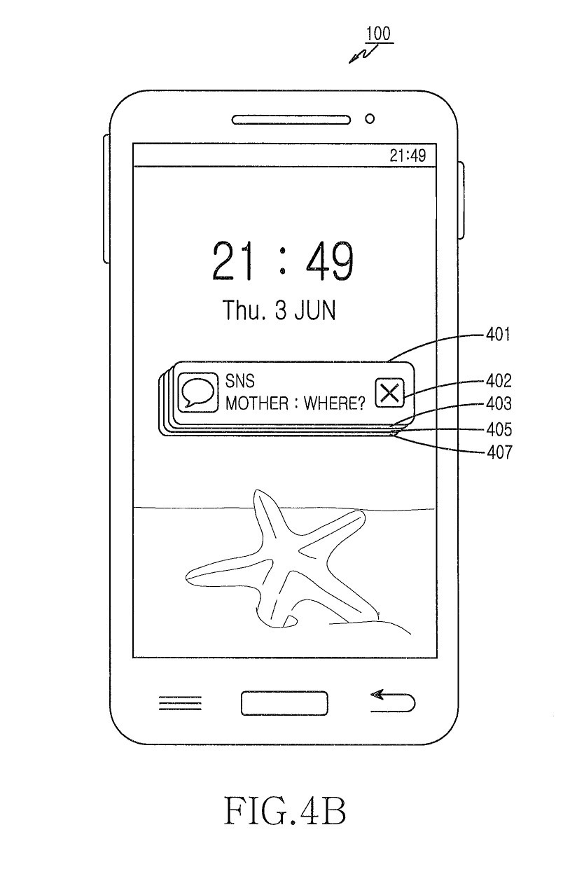

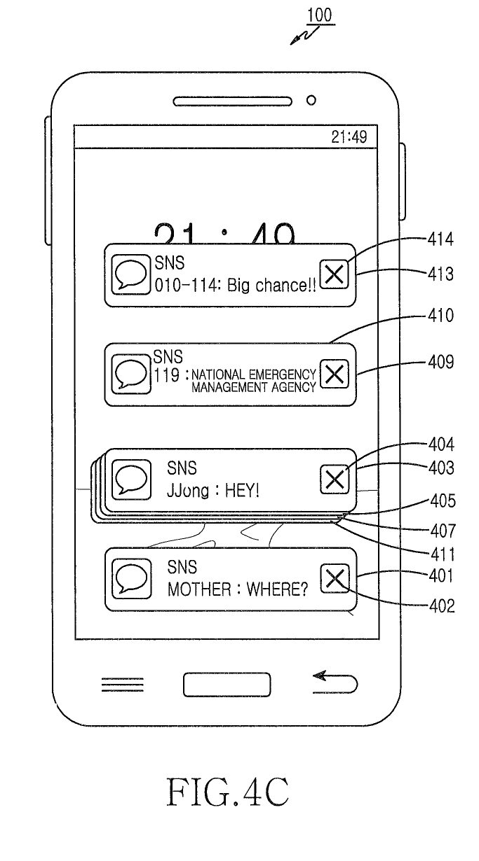

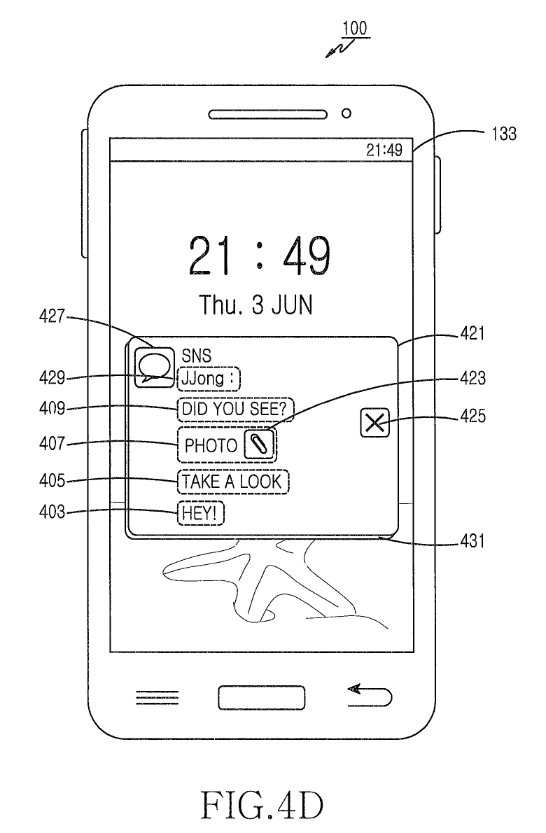

FIGS. 4A to 4D illustrate an operation of displaying a message notification window in the electronic device according to various exemplary embodiments of FIG. 1.

The electronic device 100 can display a notification of a received message in a predetermined region of the touchscreen 133 of the electronic device 100. The electronic device 100 can display a received message notification window on the touchscreen 133 as in FIGS. 4A to 4D, or can output a voice through the speaker 141 although not illustrated.

In FIG. 4A, if receiving messages, the electronic device can display the received messages on the touchscreen 133 in order of message reception time, respectively.

According to one exemplary embodiment, the electronic device 100 can display a message notification window 401 received from ‘mother’ among seven message notification windows displayed on the touchscreen 133, as a firstly received message notification in a lower region of the touchscreen 133, and can display the received message notification windows in a method of piling the received message notification windows up on the message notification window 401 in order of time of receiving the remnant six messages. In displaying the received message notification windows on the touchscreen 133, the electronic device 100 can display the received message notification windows in order of receiving the messages as in FIG. 4A, without separately distinguishing senders who have sent the messages.

If a received message includes accompanying data among the received message notification windows displayed on the touch screen 133, the electronic device 100 can display an accompanying data icon 408 to indicate that the received message includes the accompanying data.

If the electronic device 100 performs a gesture for the accompanying data icon 408, the electronic device 100 can display the accompanying data according to the gesture in a method of FIG. 2A and operation (2); FIG. 2B and operation (2), FIG. 2C and operation (2), FIG. 3A and operation (2), FIG. 3B and operation (2), or FIG. 3B and operation (2).

By choosing the confirmation icon 402, 404, 406, 410, 412 or 414 included in the received message notification window displayed on the touchscreen 113, the electronic device 100 can determine a received message confirmation state of a database as a state such as ‘reception confirmation’ or ‘read’ through the notification processing program 116.

In FIG. 4B, if receiving messages, the electronic device 100 can display the messages on the touchscreen 133 in order of message reception time.

According to one exemplary embodiment, referring to FIG. 4A, the electronic device 100 can display the message notification window 413 of the latest message received from ‘010-114’ at the bottom of the message notification windows such that the electronic device 100 can first read a firstly received message received from ‘mother’ among the seven received messages, and the electronic device 100 can pile up the message notification windows in reverse order of time of receiving the messages. The electronic device 100 can display the message notification window 401 of the firstly received message received from ‘mother’ at the top of the received message notification windows such that the electronic device 100 can confirm the messages in order of receiving the messages. The electronic device 100 can determine a received message confirmation state of a database as ‘reception confirmation’ or ‘read’ by choosing the confirmation icon 402 displayed in the message notification window 401 and can cancel the displaying of the confirmed message notification window 401 and then, can display the next received message 403. Referring to FIG. 4A, the electronic device 100 can confirm the accompanying data icon 408 in the fourthly received message notification window 407. The electronic device 100 can display some of the received messages like the notification windows (401, 403, 405, and 407 of FIG. 4B) of a previously limited number, instead of displaying all of the received messages.

In FIG. 4C, if receiving messages, the electronic device 100 can display the messages on the touchscreen 133 according to senders sending the messages and time of receiving the messages.

According to one exemplary embodiment, referring to FIG. 4A, the electronic device 100 can sort seven received messages according to senders. The electronic device 100 can sort the received messages by senders of ‘mother’ 401, ‘Bong’ 403, 405, 407, and 411, ‘119’ 409, and ‘010-414’ 413 and display the sorted received messages on the touchscreen 133.

If receiving a plurality of messages from the same sender, the electronic device 100 can display the plurality of messages in order of time of receiving the messages. When displaying the messages 403, 405, 407, and 411 received from ‘Bong’, the electronic device 100 can display the message notification window 411 of the latest message ‘Did you see?’ at the bottom of the message notification windows such that the electronic device 100 can first read a firstly received message ‘Hey!’ 403, and the electronic device 100 can pile the message notification windows up on the message notification window 411 in reverse order of time of receiving the messages (i.e., in order of 411, 407, 405, and 403). The electronic device 100 can display the message notification window 403 of the firstly received message ‘Hey!’ at the top of the message notification windows received from ‘Bong’ such that the electronic device 100 can confirm the messages in order of receiving the messages. The electronic device 100 can determine a received message confirmation state of a database as ‘reception confirmation’ or ‘read’ by choosing the confirmation icon 404 displayed in the message notification window 403 and can cancel the displaying of the confirmed message notification window 403 and then, can display the next received message 405. Referring to FIG. 4A, the electronic device 100 can confirm the accompanying data icon 408 in the thirdly received message notification window 407.

Further, according to predetermined setting, the electronic device 100 can control not to display a notification of messages and accompanying data received from some senders. Though not illustrated, according to setting, the electronic device 100 can set not to display a notification of messages 409 and 413 received from non-confirmed (i.e., non-stored) senders with reference to the memory 110 of the electronic device 100 or a database.

In FIG. 4D, if receiving messages, the electronic device 100 can display the messages on the touchscreen 133 according to a sender sending the messages.

According to one exemplary embodiment, referring to FIG. 4A, the electronic device 100 can display and confirm messages received from the same sender among seven received messages in one notification window. The electronic device 100 can display message contents ‘Hey!’ (403), ‘Take a look’ (405), accompanying data (407), and ‘Did you see?’ (411) received from ‘Bong’ (i.e., sender) 429, in one notification window 421 according to time of receiving the messages. The electronic device 100 can display (423) an icon 408 of accompanying data included in a received message 407, in an accompanying data display location of one notification window 421 having displayed the received message contents 403, 405, 407, and 411.

If choosing a predefined predetermined region of the message notification window 421 such as an icon 427 of the SNS program 115 displayed on the message notification window 421, the sender ‘Bong’ 429, and the received message 403, 405, 407 or 411, the electronic device 100 can display a region capable of composing an answer to the sender ‘Hong’ of the SNS program 115 on the touchscreen 133 of the electronic device 100.

The electronic device 100 can display one confirmation icon 425 in one notification window 421 displaying various messages received from the sender ‘Bong’. By choosing the predefined predetermined region of the message notification window 421 such as the icon 427 of the SNS program 115, the sender ‘JJong’ 429, the received message 403, 405, 407 or 411 and the confirmation icon 425, the electronic device 100 can cancel the displaying of four messages 403, 405, 407 and 411 displayed in one notification window 421, and can determine a received message confirmation state of a database for the four messages (403, 405, 407 and 411 of FIG. 4A) received from the same sender ‘Hong’, as ‘reception confirmation’ or ‘read’.

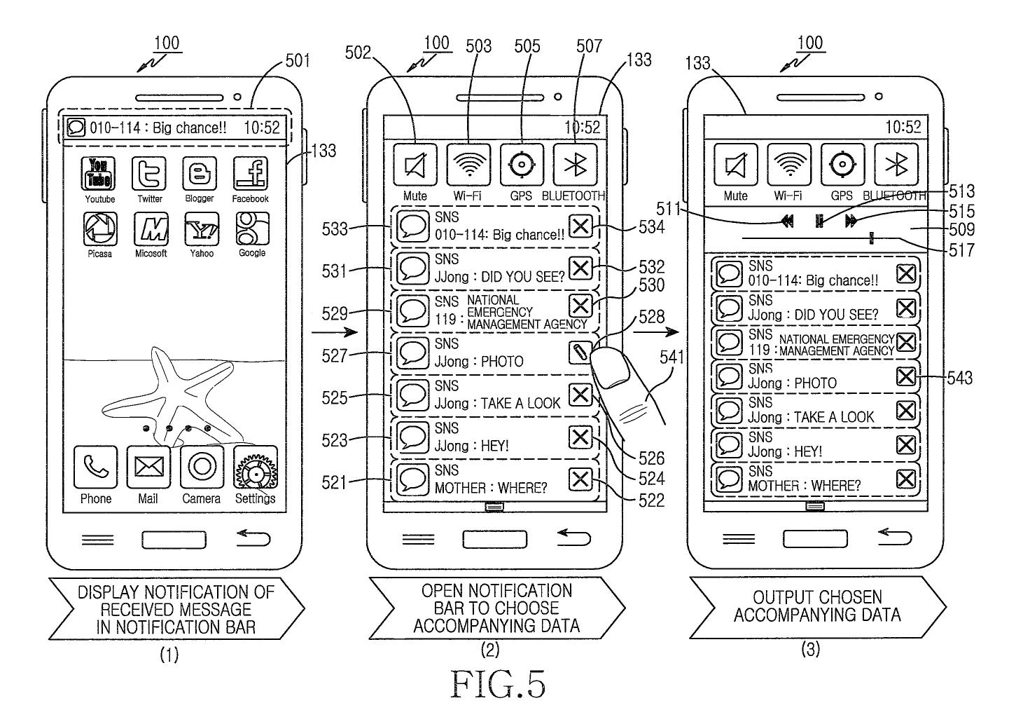

FIG. 5 illustrates an operation of processing a message notification bar and accompanying data in the electronic device according to various exemplary embodiments of FIG. 1.

Referring to FIG. 5 and operation (1), when the electronic device 100 opens the notification bar 501 of the touchscreen 133, the electronic device 100 can display one or more of a ‘Mute’ icon 502 for turning ON or OFF a mute function of the electronic device 100, a ‘Wi-Fi’ icon 503 for turning ON or OFF a Wi-Fi function of the electronic device 100, a ‘GPS’ icon 505 for turning ON or OFF a GPS function of the electronic device 100, and a ‘Bluetooth’ icon 507 for turning ON or OFF a Bluetooth function of the electronic device 100.

The electronic device 100 can display a received message notification in a predetermined region of the touchscreen 133 of the electronic device 100. The electronic device 100 can display the received message notification at a notification bar 501 of the touchscreen 133, or can output the received message notification by a voice through the speaker 141 although not illustrated. By choosing accompanying data included in a received message, the electronic device 100 can output the contents of the accompanying data.

In operation (1), the electronic device can display a received message notification at the notification bar 501.

According to one exemplary embodiment, if displaying the received message notification at the notification bar 501, the electronic device 100 can confirm received messages at the notification bar 501 by touching the notification bar 501 displaying the received messages and holding and dragging down the touch.

In operation (2), by choosing an icon 528 of accompanying data included in a received message displayed at the notification bar 501, the electronic device 100 can confirm the contents of the accompanying data.

According to one exemplary embodiment, the electronic device 100 can display the received message notification at the notification bar 501 as in the operation (1), and can choose and open the notification bar 501 and display the received messages at the opened notification bar 501 according to message reception time as in FIG. 4A, respectively. In displaying the received messages at the notification bar 501, the electronic device 100 is not limited to displaying the received messages according to the message reception time, and can pile up and display notification windows according to the message reception time as in FIG. 4B, and can sort and display the notification windows by senders having sent the messages as in FIG. 4D.

If a message corresponding to a received message notification 527 displayed at the notification bar 501 includes accompanying data, the electronic device 100 can display the icon 528 of the accompanying data in a predetermined region of the received message notification 527. By choosing (541) the displayed icon 528 of the accompanying data, the electronic device 100 can output the contents of the accompanying data.

In operation (3), the electronic device 100 can output the contents of the chosen accompanying data.

According to one exemplary embodiment, the electronic device 100 can display the icon 528 of the accompanying data included in the received message of the received message notification 527 displayed at the notification bar 501, in a predetermined region of the message notification 527. If choosing the icon 528 of the accompanying data, the electronic device 100 can output the contents of the accompanying data.

If the accompanying data is media data including a sound, the electronic device 100 can output the media data through the speaker 141. The electronic device 100 can perform an operation of outputting the media data without displaying the SNS program 115 receiving the media data on the touchscreen 133. The electronic device 100 can display a tool 509 for confirming and controlling a media data output state at the notification bar 501, as in FIG. 5 and operation (3). In displaying the tool 509 for confirming and controlling the media data output state, the electronic device 100 is not limited to displaying the tool 509 at the notification bar 501, and can display the tool 509 in a predetermined region of the touchscreen 133 of the electronic device 100, or can output the tool 509 in a message sending/reception region of the SNS program 115 corresponding to the sender ‘Bong’ having sent the accompanying data. The electronic device 100 can include a play and stop icon 513, a reverse icon 511, a forward icon 514, a volume adjustment icon 517 and the like, as constructions of the tool 509 for confirming and controlling the media data output state.

If the accompanying data is still picture (image) data, the electronic device 100 cannot merely display the image data on a wallpaper screen of the touchscreen 133 of the electronic device 100 or a wallpaper screen of the SNS program 115 as in FIG. 2A and operation (2), FIG. 2B and operation (2), FIG. 2C and operation (2), FIG. 3A and operation (2), FIG. 3B and operation (2), and FIG. 3C and operation (2), but also can display the image data on a wallpaper screen of the notification bar 501.

If outputting the accompanying data, the electronic device 100 can change the icon 528 of the accompanying data displayed in the received message notification 527 into a confirmation icon 543, and display the confirmation icon 543.

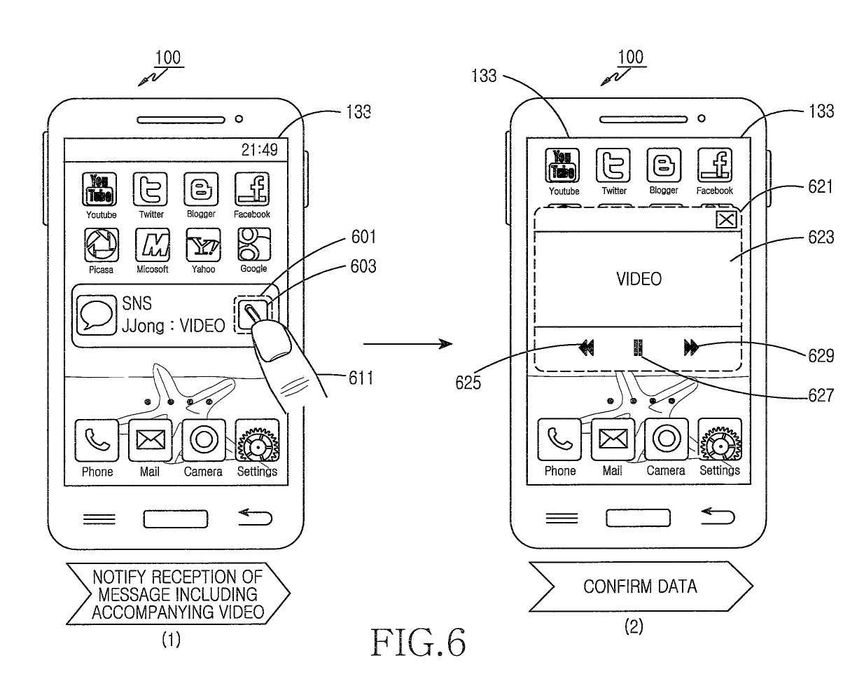

FIG. 6 illustrates an operation of processing accompanying data in the electronic device according to various exemplary embodiments of FIG. 1.

The electronic device 100 can display a received message notification in a predetermined region of the touchscreen 133 of the electronic device 100. The electronic device 100 can display the received message notification at a notification window or notification bar of the touchscreen 133, or can output the received message notification by a voice through the speaker 141. By choosing accompanying data included in a received message, the electronic device 100 can output the contents of the accompanying data.

In operation (1), the electronic device 100 can display a received message notification in a notification window 601 and, by choosing an icon 603 of accompanying data included in a received message, the electronic device 100 can confirm the contents of the accompanying data.

According to one exemplary embodiment, the electronic device 100 can display the received message notification in the message notification window 601 and, if the received message includes the accompanying data, the electronic device 100 can display the icon 603 of the accompanying data in a predetermined region of the message notification window 601. By choosing the displayed accompanying data, the electronic device 100 can confirm the contents of the accompanying data.

In operation (2), the electronic device 100 can output the contents of the chosen accompanying data.

According to one exemplary embodiment, if the accompanying data is media data including a moving picture, the electronic device 100 can perform an operation of outputting the media data, with not displaying the SNS program 115 receiving the media data on the touchscreen 133. The electronic device 100 can include a tool 621 for confirming and controlling an output state of the moving-picture media data as in FIG. 6 (2) and can output (623) the tool 621 to a predetermined region of the touchscreen 133 and output sound data included in the moving-picture media data through the speaker 141. In displaying the tool 621 for confirming and controlling the media data output state, the electronic device 100 is not limited to displaying the tool 621 on an operating screen of the touchscreen 133, and can display the tool 621 in the same method as the tool 509 by opening the notification bar 501 of the electronic device 100 or can output the tool 621 in a message sending/reception region of the SNS program 115 corresponding to the sender ‘Hong’ having sent the accompanying data. The electronic device 100 can include a play and stop icon 627, a reverse icon 625, a forward icon 629, a volume adjustment icon (not shown) and the like as constructions of the tool 621 for confirming and controlling the media data output state, in a region 623 capable of outputting the moving picture. If choosing an X icon, the electronic device 100 can cancel the displaying of the tool 621.

If outputting the accompanying data, the electronic device 100 can change the icon 603 of the accompanying data displayed in the received message notification window 601 into a confirmation icon (not shown) and display the confirmation icon (not shown). The electronic device 100 can cancel the displaying of the received message notification window 601 by predefined setting and determine a received message confirmation state of a database as ‘reception confirmation’ or ‘read’.

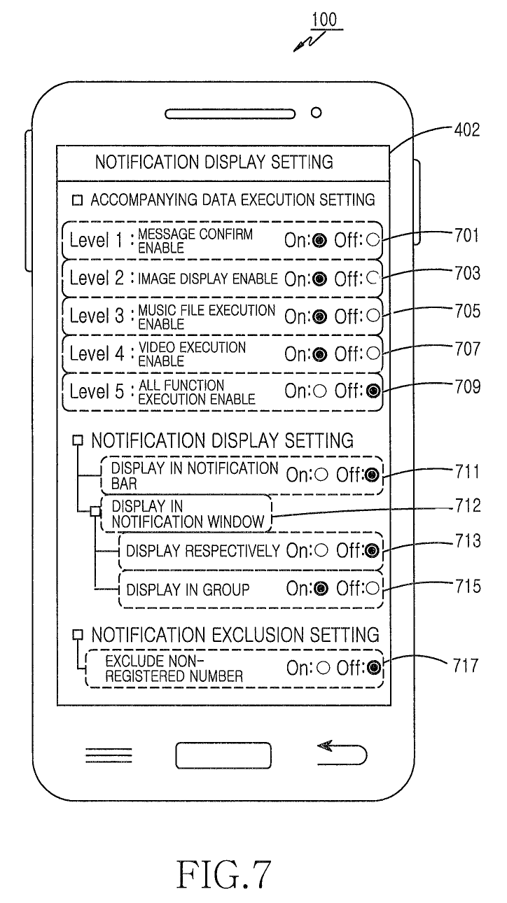

FIG. 7 illustrates a notification setting operation in the electronic device according to various exemplary embodiments of FIG. 1.

The electronic device 100 can set a method of displaying a notification of a received message and accompanying data through setting of the notification processing program 115, and a method of processing when choosing the accompanying data in the displayed notification.

According to one exemplary embodiment, the electronic device 100 can set the step of processing a received message and accompanying data included in the received message in the setting step of the notification processing program 116. Referring to FIG. 7, the electronic device 100 can set a message and accompanying data processing level by five levels at a ‘notification control level’.

If choosing ‘Level 1: message confirm enable’ 701 as ‘ON’, the electronic device 100 can display message contents through a received message notification window or notification bar. When a received message includes accompanying data, the electronic device 100 may not display a notification of the accompanying data in the received message notification window or notification bar. When displaying the notification of the accompanying data in the received message notification window or notification bar, the electronic device may not output the contents of the accompanying data although choosing an accompanying data notification. When not outputting the contents of the accompanying data according to setting, the electronic device 100 can display a ‘limited setting’ notification.

If choosing ‘Level 2: image display enable’ 703 as ‘ON’, the electronic device 100 can display message contents through a received message notification window or notification bar. When accompanying data included in a received message is a still picture (image), the electronic device 100 can display an accompanying data notification in the received message notification window or notification bar. When the accompanying data corresponding to the accompanying data notification displayed in the received message notification window or notification bar is not an image, the electronic device 100 may not output the contents of the accompanying data although choosing the accompanying data notification. When not outputting the contents of the accompanying data according to the setting, the electronic device 100 can display the ‘limited setting’ notification.

If choosing ‘Level 3: audio execution enable’ 705 as ‘ON’, the electronic device 100 can display message contents through a received message notification window or notification bar. When accompanying data included in a received message is audio data, the electronic device 100 can display an accompanying data notification in the received message notification window or notification bar. When the accompanying data corresponding to the accompanying data notification displayed in the received message notification window or notification bar is not audio data, the electronic device 100 may not output the contents of the accompanying data although choosing the accompanying data notification. When not outputting the contents of the accompanying data according to the setting, the electronic device 100 can display the ‘limited setting’ notification.

If choosing ‘Level 4: video execution enable’ 707 as ‘ON’, the electronic device 100 can display message contents through a received message notification window or notification bar. If accompanying data included in a received message is moving picture data (i.e., video data, and data including a video and an audio), the electronic device 100 can display an accompanying data notification in the received message notification window or notification bar. If accompanying data corresponding to the accompanying data notification displayed in the received message notification window or notification bar is not moving picture data, the electronic device 100 may not output the contents of the accompanying data although choosing the accompanying data notification. When not outputting the contents of the accompanying data according to the setting, the electronic device 100 can display the ‘limited setting’ notification.

If choosing ‘Level 5: all function execution enable’ 709 as ‘ON’, the electronic device 100 can display message contents through a received message notification window or notification bar. When a received message includes accompanying data such as image data, audio data or video data, the electronic device 100 can display an accompanying data notification in the received message notification window or notification bar. When choosing the accompanying data notification displayed in the received message notification window or notification bar and an instruction included in the message such as a hyperlink and the like, the electronic device 100 can output the image data, audio data or moving picture data corresponding to the accompanying data notification, and can perform the instruction included in the message. When not outputting the contents of the accompanying data according to the setting, the electronic device 100 can display the ‘limited setting’ notification.

According to one exemplary embodiment, the electronic device 100 can set a method of displaying a notification of a received message and accompanying data included in the received message, in the setting step of the notification processing program 116.

If choosing ‘display in notification bar’ 711 as ‘ON’, the electronic device 100 can display in the notification bar a notification of a received message and accompanying data included in the received message.

If choosing ‘display in notification window’ 712 as ‘ON’, the electronic device 100 can display in the notification window a notification of a received message and accompanying data included in the received message. If choosing the ‘display in notification window’ 712 and then choosing ‘display respectively’ 713 as ‘ON’ in detailed setting, the electronic device 100 can display received messages, respectively, as in FIG. 4A.

If choosing the ‘display in notification window’ 712 and then choosing ‘display by group’ 715 as ‘ON’ in detailed setting, the electronic device 100 can sort received messages by senders and display the sorted messages in group as in FIG. 4B or FIG. 4C.

According to one exemplary embodiment, if choosing ‘exclude non-registered number’ 717 as ‘ON’ in the setting step of the notification processing program 116, the electronic device 100 may not display a notification of a message and accompanying data that are received from a sender who is not stored in the memory 110 of the electronic device 100 or the database.

The electronic device 100 can set a method of displaying and processing a received message and accompanying data through the above various setting steps.

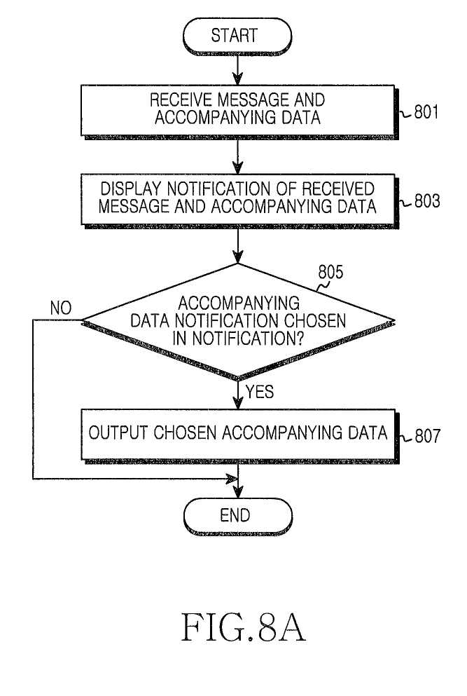

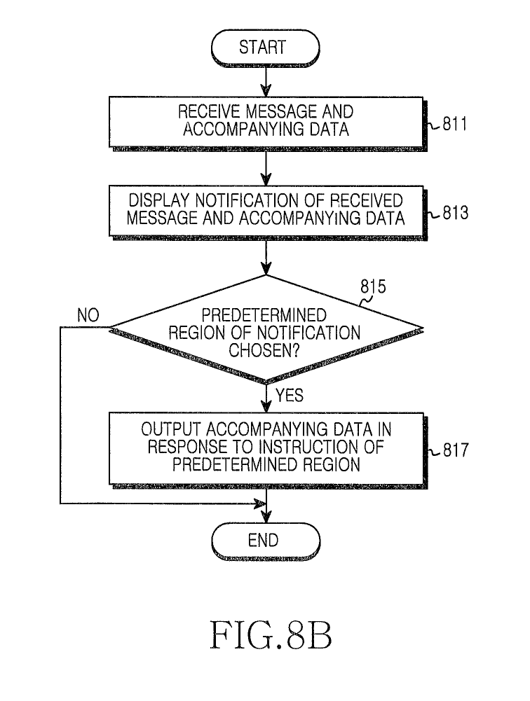

FIGS. 8A and 8B are flowcharts illustrating operations in the electronic device according to various exemplary embodiments of FIG. 1.

The electronic device 100 can receive message data and accompanying data, and can display a reception notification of the message data and accompanying data, and can choose the accompanying data in the displayed notification, and can output the contents of the chosen accompanying data.

FIG. 8A is a flowchart illustrating an operation when choosing accompanying data in a notification of a message including the accompanying data.

In operation 801, the electronic device 100 can receive SNS message data from other electronic devices, a specific server, the Internet and the like through network communication. The SNS message data can be composed of a message capable of being confirmed in the SNS program 115 and accompanying data additionally accompanied to the message.

To confirm the contents of accompanying data received through the SNS program 115 in a general method, the electronic device 100 can use a data output program provided by the SNS program 115 during an operation of the SNS program 115, or use a program (not shown) for enabling the SNS program 115 to download the accompanying data to a memory of the electronic device 100 and output the accompanying data from the memory of the electronic device 100.

In operation 803, the electronic device 100 can display a notification of the received message and/or a notification of the accompanying data included in the received message, in a predetermined region of the touchscreen 133 through the notification processing program 116.

Through a notification window, the electronic device 100 can display the notification of the received message and the notification of the accompanying data included in the received message. In displaying the received message notification and the accompanying data notification through the notification window, the electronic device 100 can display the received message notification and the accompanying data notification in methods of FIG. 4A to FIG. 4D.

Through a notification bar, the electronic device 100 can display the notification of the received message and the notification of the accompanying data included in the received message. In displaying the received message notification and the accompanying data notification through the notification bar, the electronic device 100 can display the received message notification and the accompanying data notification as in a method of FIG. 5.

In displaying the notification of the received message and the accompanying data through the notification processing program 116, the electronic device 100 can construct and display an icon including an instruction of controlling to enable a program capable of confirming the received message, a region displaying a sender who has sent the message and a region including an instruction of controlling to enable an SNS program screen capable of sending/receiving a message, a confirmation icon capable of determining a received message reception state of a database as a ‘reception confirmation’ or ‘read’ state, and an icon including an instruction of controlling to output the accompanying data.

In operation 805, the electronic device 100 can determine whether it chooses a predetermined region of the message notification displayed through a notification of the notification processing program 116 or whether it chooses the accompanying data notification.

Referring to FIG. 4D, one exemplary embodiment of displaying the notification of the received message and the accompanying data can include and construct at least one of an icon 427 including an instruction of controlling to enable the SNS program 115 capable of confirming the received message, a region 429 displaying a sender who has sent the message and a region 403, 405, 407 or 409 including an instruction of controlling to enable an SNS program screen capable of sending/receiving a message, an icon 423 including an instruction of controlling to output the accompanying data, and a confirmation icon 425 capable of determining a received message reception state of a database as a ‘reception confirmation’ or ‘read’ state.

The electronic device 100 can determine if one of the constructions of the notification is chosen. The electronic device 100 can perform operation 807 when choosing the icon 423 including the instruction of controlling to output the accompanying data among the constructions of the notification.

In operation 807, if choosing an icon corresponding to the accompanying data in the received message notification, the electronic device 100 can directly execute the chosen accompanying data.

According to one exemplary embodiment, the accompanying data included in the received message can be image data. If receiving a message in a wait mode as in FIG. 2A and operation (1), the electronic device 100 can just choose an accompanying data notification to confirm the accompanying data included in the message. The electronic device 100 can display the chosen image data on a wait mode screen. When outputting the accompanying data, the electronic device 100 can change an accompanying data icon displayed in a message notification into a confirmation icon (i.e., the aforementioned X icon) and display the confirmation icon. When choosing the confirmation icon, the electronic device 100 can determine a message confirmation state of a database as ‘reception confirmation’ or ‘read’.

According to one exemplary embodiment, the electronic device 100 can display a notification of a received message and accompanying data in a notification bar as in FIG. 5 and operation (1). The received message can be audio data. To confirm the accompanying data, the electronic device 100 can choose the accompanying data notification icon 528 of the message notification. The electronic device 100 can output the accompanying data, and can display (509) a tool capable of controlling the output audio data in the notification bar.

If performing operation 807, the electronic device 100 can terminate the operation of FIG. 8A.

FIG. 8B is a flowchart illustrating an operation when choosing a message notification region in a notification of a message including accompanying data.

In operation 811, the electronic device 100 can receive SNS message data from other electronic devices, a specific server, the Internet and the like through network communication. The SNS message data can be composed of a message capable of being confirmed in the SNS program 115 and accompanying data additionally accompanied to the message.

To confirm the contents of accompanying data received through the SNS program 115 in a general method, the electronic device 100 can use a data output program provided by the SNS program 115 during an operation of the SNS program 115, or use a program (not shown) for enabling the SNS program 115 to download the accompanying data to a memory of the electronic device 100 and output the accompanying data from the memory of the electronic device 100.

In operation 813, the electronic device 100 can display a notification of the received message and/or a notification of the accompanying data included in the received message, in a predetermined region of the touchscreen 133 through the notification processing program 116.

Through a notification window, the electronic device 100 can display the notification of the received message and the notification of the accompanying data included in the received message. In displaying the received message notification and the accompanying data notification through the notification window, the electronic device 100 can display the received message notification and the accompanying data notification in methods of FIG. 4A to FIG. 4D.

Through a notification bar, the electronic device 100 can display the notification of the received message and the notification of the accompanying data included in the received message. In displaying the received message notification and the accompanying data notification through the notification bar, the electronic device 100 can display the received message notification and the accompanying data notification as in a method of FIG. 5.

In displaying the notification of the received message and the accompanying data through the notification processing program 116, the electronic device 100 can construct and display an icon including an instruction of controlling to enable a program capable of confirming the received message, a region displaying a sender who has sent the message and a region including an instruction of controlling to enable an SNS program screen capable of sending/receiving a message, a confirmation icon capable of determining a received message reception state of a database as a ‘reception confirmation’ or ‘read’ state, and an icon including an instruction of controlling to output the accompanying data.

In operation 815, the electronic device 100 can determine whether it chooses a predetermined region of the message notification displayed through a notification of the notification processing program 116 or whether it chooses the accompanying data notification.

Referring to FIG. 4D, one exemplary embodiment of displaying the notification of the received message and the accompanying data can include and construct at least one of an icon 427 including an instruction of controlling to enable the SNS program 115 capable of confirming the received message, a region 429 displaying a sender who has sent the message and a region 403, 405, 407 or 409 including an instruction of controlling to enable an SNS program screen capable of sending/receiving a message, an icon 423 including an instruction of controlling to output the accompanying data, and a confirmation icon 425 capable of determining a received message reception state of a database as a ‘reception confirmation’ or ‘read’ state.

The electronic device 100 can determine if one of the constructions of the notification is chosen. The electronic device 100 can perform operation 817 when choosing one region among the icon 427 including the instruction of controlling to enable the SNS program 115 capable of confirming the received message, the region 429 displaying the sender who has sent the message and the region 403, 405, 407 or 409 including the instruction of controlling to enable the SNS program screen capable of sending/receiving the message among the constructions of the notification.

In operation 817, if choosing a predetermined region of the received message notification, the electronic device 100 can directly execute the chosen accompanying data.

According to one exemplary embodiment, the electronic device 100 can display a notification of a received message and accompanying data in a notification bar as in FIG. 5 and operation (1). The received message can be audio data. To confirm the accompanying data, the electronic device 100 can choose a predetermined region of the message notification. If choosing an icon 335 region of a program receiving a message as in FIG. 3C and operation (1), the electronic device 100 can display an SNS program page corresponding to the corresponding message, and can output the accompanying data as background music of an SNS program. If displaying the SNS program page corresponding to the chosen message, the electronic device 100 can determine a message confirmation state of a database as ‘reception confirmation’ or ‘read’.

If performing operation 817, the electronic device 100 can terminate the operation of FIG. 8B.

As described above, an electronic device can display a notification of a received message and accompanying data included in the received message through various methods and, through simple handling of the displayed notification, can confirm the accompanying data included in the message by means of various functions operating in the electronic device.

Methods according to exemplary embodiments disclosed in claims and/or specification of the disclosure can be implemented in a form of hardware, software, or a combination of hardware and software.

In a case of implementing in the software form, a computer readable storage medium storing one or more programs (i.e., software modules) can be provided. One or more programs stored in the computer readable storage medium are configured to be executed by one or more processors within an electronic device 100. The one or more programs can include instructions for enabling the electronic device 100 to execute the methods according to the exemplary embodiments disclosed in the claims and/or specification of the disclosure.

These programs (i.e., software modules or software) can be stored in a Random Access Memory (RAM), a nonvolatile memory including a flash memory, a Read Only Memory (ROM), an Electrically Erasable Programmable ROM (EEPROM), a magnetic disk storage device, a Compact Disk ROM (CD-ROM), a Digital Versatile Disk (DVD) or an optical storage device of other form, and a magnetic cassette. Or, the programs can be stored in a memory configured by a combination of some or all of them. Also, each configuration memory may be included in plural number.

Also, the programs can be stored in an attachable storage device accessible to the electronic device through a communication network such as the Internet, an intranet, a Local Area Network (LAN), a Wireless LAN (WLAN) and a Storage Area Network (SAN) or a communication network configured by a combination of them. This storage device can access the electronic device 100 through an external port.

Also, a separate storage device on a communication network may access the portable electronic device 100.

While the disclosure has been shown and described with reference to certain preferred embodiments thereof, it will be understood by those skilled in the art that various changes in form and details may be made therein without departing from the spirit and scope of the disclosure as defined by the appended claims.

1-20. (canceled)

21. An apparatus comprising:
a display; and
a processor operatively coupled with the display, the processor configured to:
receive a message associated with an application from an electronic device external to the apparatus;
present, via at least a portion of the display, a notification corresponding to the message, the presenting including presenting a menu in relation with the notification, the menu to be used to set the message as read;
identify an input associated with the menu; and
terminate the presenting of at least one of the notification or the menu from the display in response to the input.

22. The apparatus of claim 21, wherein the processor is configured to set the message as read in response to the input.

23. The apparatus of claim 22, wherein the processor is configured to refrain from presenting the application in the setting of the message as read.

24. The apparatus of claim 21, wherein the processor is configured to present another menu in relation with the notification, the other menu to be used to reply the message.

25. The apparatus of claim 24, wherein the processor is configured to:
identify another input associated with the other menu; and
present, in response to the other input, a user interface to be used to reply the message.

26. The apparatus of claim 25, wherein the user interface is to be executed as a function of the application.

27. The apparatus of claim 25, wherein the user interface is to be executed as a function of another application.

28. The apparatus of claim 25, wherein the processor is configured to present at least a portion of the message in relation with the user interface in response to the other input, the presenting of the user interface including refraining from presenting any message other than the message.

29. The apparatus of claim 21, wherein the processor is configured to present another menu in relation with the notification, the other menu to be used to present content of a file accompanying the message.

30. The apparatus of claim 21, wherein the processor is configured to present at least one of the notification or the menu while a wait mode screen is presented via the display.

31. The apparatus of claim 30, wherein the processor is configured to present content of a file accompanying the message while the wait mode screen is presented via the display.

32. The apparatus of claim 30, wherein the wait mode screen comprises a lock screen to disable at least one user input to the apparatus compared to a normal mode screen for the apparatus.

33. The apparatus of claim 31, wherein the menu comprises at least one of an icon, an image or a text.

34. An apparatus comprising:
a display configured to present at least one screen; and
a processor operatively coupled with the display, the processor configured to:
receive a message associated with an application from an electronic device external to the apparatus;
present a notification corresponding to the message via a first screen, the presenting including presenting a menu in relation with the notification, the menu to be used to set the message as read;
identify an input associated with the menu; and
present a second screen in response to the input, the presenting of the second screen including deleting at least one of the notification or the menu from the second screen.

35. The apparatus of claim 34, wherein the second screen comprises a screen associated with another application.

36. The apparatus of claim 34, wherein the first screen and the second screen are a same screen.

37. The apparatus of claim 34, wherein the processor is configured to set the message as read in response to the input.

38. The apparatus of claim 34, wherein the processor is configured to present at least one of the notification or the menu translucently or transparently.

39. An apparatus comprising:
a display configured to present at least one screen; and
a processor operatively coupled with the display, the processor configured to:
receive a message associated with an application from an electronic device external to the apparatus;
present, via the display, a notification corresponding to the message;
identify an input to select the notification; and
present a user interface to be used to reply the message in response to the input, the presenting of the user interface including refraining from presenting the application.

40. The apparatus of claim 39, wherein the processor is configured to present at least a portion of the message in relation with the user interface in response to the input, the presenting of the user interface including refraining from presenting any message other than the message.

41. The apparatus of claim 39, wherein the processor is configured to set the message as read in response to the input.

42. A method comprising:
receiving, at an electronic device, a message associated with an application from another electronic device external to the electronic device;
presenting a notification corresponding to the message via a display operatively coupled with the electronic device, the presenting including presenting a menu in relation with the notification, the menu to be used to set the message as read;
identifying an input associated with the menu; and
terminating the presenting of at least one of the notification or the menu in response to the input.

43. The method of claim 42, wherein identifying the input comprises setting the message as read in response to the input.

44. The method of claim 43, wherein terminating the presenting comprises refraining from presenting the application in the setting of the message as read.

45. The method of claim 42, wherein presenting the notification comprises presenting at least one of the notification or the menu while a lock screen is presented via the display.
